(19) United States
(12) Patent Application Publication
(10) Pub. No.: US 2014/0353286 A1
(43) Pub. Date: Dec. 4, 2014

(54) METHOD FOR GAS METAL ARC WELDING

(71) Applicant: Erwan Siewert, Munich (DE)

(72) Inventor: Erwan Siewert, Munich (DE)

(21) Appl. No.: 14/277,448

(22) Filed: May 14, 2014

(30) Foreign Application Priority Data
Jun. 4, 2013 (DE) 102013009350.3
Nov. 28, 2013 (DE) 102013018065.1

(51) Int. Cl. B23K 9/10; B23K 9/09; B23K 9/173

(52) U.S. Cl. CPC B23K 9/1012; B23K 9/173; B23K 9/09
USPC 219/74; 219/130.1; 219/130.51

(57) ABSTRACT

A method for gas metal arc welding is disclosed, wherein a welding current is passed through a wire electrode and the a wire electrode is melted by a welding arc, wherein at least one parameter that influences Joulean heating of the wire electrode is adjusted.

### CROSS REFERENCE TO RELATED APPLICATIONS

This application claims priority from German Patent Application Serial No. 102013009350.3 filed Jun. 4, 2013 and German Patent Application Serial No. 102013018065.1 filed Nov. 28, 2013.

### BACKGROUND OF THE INVENTION

The invention relates to a method and a device for gas metal arc welding. In this context, a welding current is passed through a wire electrode and the electrode is melted by a welding arc.

Gas metal are welding (GMAW) is an arc welding method that is used for example in additive welding, or to weld or solder together one, two or more workpieces made from a metal material. In this method, a wire electrode in the form of a wire or strip is fed continuously in a shielded metal gas atmosphere and melted by a welding arc that burns between the workpiece and the wire electrode. In such an instance, the workpiece functions as a second electrode. In particular, the workpiece functions as the cathode, while the wire electrode is the anode. As a result of cathodic effects, the workpiece is at least partly melted and forms the molten bath. One end of the wire electrode is melted, mainly by the action of the welding torch, and a molten, fluid bead forms. Under the effects of several different forces, the bead is separated from the wire electrode and is transferred to the molten bath. This process of melting the wire electrode, forming the bead, separating the bead and interaction between the bead and the workpiece is called material transfer.

In order for the weld bead to be separated, according to the process it is necessary to overheat the wire. This results in vaporisation of the wire electrode which in turn causes the release of large quantities of harmful emissions as welding smoke. Welding smoke consists of particulate contaminants (mostly metal oxides) that can be breathed in, are able to infiltrate the alveolae, and may be toxic and/or carcinogenic. Such emission particles are particularly likely to damage the health of a welder.

However, since the wire electrode functions not only as a conductor of the welding arc but also as the filler material or welding additive, and is transferred to the molten bath and thus ultimately to the joint, there is a rigid correlation between the melting power and the amount of energy introduced into the workpiece. The energy introduced, that is to say the energy that is introduced into the workpiece by the welding arc, is thus dependent upon the melting power that is used to melt the wire electrode. It follows that the melting power can only be varied within narrow limits, otherwise it will affect the entire welding process.

The heating of the wire electrode can be influenced by varying the energy in the welding arc. For example, a contact point of the welding arc with the wire electrode (welding arc contact point) or pulsed forms of the welding arc when it burns as a pulsed welding arc may be varied to this end. However, the correlation between the melting power and the energy input means that overheating of the wire most be taken into account so that the weld bead can still be separated.

In order to reduce the toxic burden and the risk to the health of the welder, respirators can be used, or the emission particles can be extracted by means of extraction torches. However, extraction torches also have considerable disadvantages. If extraction torches are used, they will result in a clumsier construction and accessibility will be significantly restricted. Handling will be made much more difficult for the welder. Furthermore, it is often not possible to trap the emission particles reliably with simple filters. And the emission particles usually remain suspended very close to the workpiece surface, and are very difficult if not impossible for the extraction torch to trap.

The object underlying the invention is therefore to reduce the risk to the welder's health from released emission particles when the welder is engaged in shielded metal arc welding.

### SUMMARY OF THE INVENTION

This object is solved with a method and device for gas metal arc welding wherein a welding current is passed through a wire electrode and the wire electrode is melted by a welding arc characterized in that at least one parameter that influences the Joulean heating of the wire electrode is adjusted. The device for gas metal arc welding, comprising a wire electrode through which a welding current is passed, characterized in that the device is configured so as to adjust at least one parameter that influences Joulean heating of the wire electrode. In this context, a welding current is passed through the wire electrode, which is melted with a welding torch. According to the invention, at least one parameter that influences Joulean heating of the wire electrode is set.

The welding current is supplied by a welding current source. Said welding current source is connected on the one hand to the wire electrode and on the other to the workpiece. The wire electrode may be either positively or negatively polarised. The welding current may be either alternating current or direct current.

The gas metal arc welding method according to the invention particularly enables an additive welding operation to be carried out. A soldering process, particularly arc soldering, may also be carried out by means of the gas metal arc welding method according to the invention. The invention is thus not intended to be limited to gas metal arc welding, but also lends itself analogously by extension to soldering, particularly arc soldering.

In conventional gas metal arc welding methods, the wire electrode is melted mainly by the welding arc. The melting of the wire electrode is thus dependent on the energy introduced by the welding arc into the wire electrode. The outer side or surface of the wire electrode, with which the welding arc is brought into contact, becomes much hotter, much more quickly, than the interior of the wire electrode. The energy input from the welding arc that is transferred from the surface to the interior of the wire electrode is also limited by thermal conductivity. The underside of the molten bead is also exposed to much more heat from the welding arc than the upper side thereof. Consequently, the wire electrode is vaporised and health-threatening welding smoke is emitted. In conventional gas metal arc welding methods, up to about 10% of the welding filler may be vaporised.

The fact that the wire electrode is heated up by the flow of current through the wire electrode and due to the electrical resistance thereof, receives scant attention in conventional gas metal arc welding methods. According to Joule's law, the heat generated by electrical resistance is proportional to the electrical power converted at the electrical resistance over a corresponding time period. Joulean heating is thus defined as a quantity of heat energy per unit of time, which arises due to continuous losses of electrical energy in a conductor as a result of the current strength and the resistance per unit length (electrical resistance of the conductor relative to its length).

Joulean heating has a considerable effect on the formation and temperature of the wire electrode heads. The temperature of the wire electrode and of the beads in turn affect the vaporisation of the wire electrode and the formation of welding smoke. In conventional gas metal arc welding methods, however, the Joulean heating of the wire electrode is only considered to be a side effect of the welding process, and it is not deliberately exploited.

With the setting according to the invention of the at least one parameter that affects the Joulean heating of the wire electrode, it becomes possible to influence the Joulean heating of the wire electrode in targeted manner. Thus, particularly the melting of the wire electrode is influenced. The Joulean heating and the associated heating up of the wire electrode is particularly marked in the interior thereof. By targeted use of Joulean heating, the wire electrode may thus be heated not only from the outside by the welding arc, but also internally by the Joulean heating. Consequently, the melting of the wire electrode is not determined solely by the energy introduced into the wire electrode from the welding arc, and it is not limited by the thermal conductivity from the surface to the interior of the wire electrode. With the invention, it is thus possible to heat the bead much more evenly. Since the wire electrode is thus heated from the inside as well as from the outside, it does not need to be heated so intensely by the welding arc as in conventional gas metal arc welding methods. Accordingly, the maximum temperature of the bead underside is reduced, so that overheating of the wire electrode is reduced substantially, if not entirely eliminated, as is the undesirable vaporisation.

The invention is thus responsible for significantly reducing the release of health-threatening emissions, particularly in the form of welding smoke and particulate emissions. This in turn improves the occupational safety of welders and lowers the risk of health injury to this group of workers. The gas metal arc welding method according to the invention also retains the known advantages of gas metal arc welding, for example the rotational symmetry of the welding arc. The current flow in the wire electrode is converted into heat with practically no loss, so that more efficient use is made of resources, rendering the gas metal arc welding method more effective and more economical.

In particular, the gas metal arc welding method according to the invention makes it easy to weld and use certain wires as wire electrodes that are otherwise very difficult or require complex arrangements in order to be used in conventional gas metal arc welding methods. In particular, relatively thick wires can easily be welded and used as wire electrodes with this method. Aluminium wires, which have only a low Joulean heating index because of their good conductivity, can also be used with ease with the aid of the invention.

In a preferred variation of the invention, a current contact point on the wire electrode is set as the at least one parameter that influences the Joulean heating of the wire electrode. The current contact point is the point on the wire electrode that the welding current reaches first. In particular, the current contact point may be adjusted by means of a suitable current contact element, for example by means of suitably designed rollers.

In conventional GMAW methods, the transition of the current to the advancing wire electrode is a non-deterministic process. It is not possible to predict precisely the exact position at which the weld current will cross over to the wire electrode, because a fixed current contact point has not been defined. As this characteristic of conventional GMAW methods is non-deterministic, the Joulean heating of the wire electrode cannot be precisely adjusted and influenced.

Unlike the above situation, according to this variant of the invention (particularly with the aid of suitable rollers), the adjustment of the current contact point is a deterministic process. Accordingly, the Joulean heating of the wire electrode may be precisely adjusted and influenced. Moreover, regulation of the welding current source and the welding process itself is simplified. And the occurrence of undesirable smaller arcs between the current contact nozzle and the wire electrode, such as can occur with current contact points that are not precisely defined, may be avoided. In this way, welding of the wire electrode to the current contact nozzle may be avoided.

According to an advantageous aspect of the invention, a free length of wire (also called the “stickout”) is set between the current contact point and a welding arc contact point on the wire electrode as the at least one parameter that influences the Joulean heating of the wire electrode. In particular, this setting is made steplessly. The free length of wire represents a current conducting part of the wire electrode, through which the welding current flows. The Joulean heating of the wire electrode therefore depends on the electrical resistance of said current conducting part of the wire electrode.

Different wire electrodes made from different materials and having different, diameters also have different resistances, which means they also generate different quantities of Joulean heating. According to conventional GMAW methods, the stickout is chosen without reference to these factors, and is set to be identical or very similar regardless of the material that makes up the wire electrode, the strength of the welding current, the shielding gases and welding arc types used. In conventional GMAW methods, the stickout is usually limited by the construction of the GMAW torch.

The GMAW method according to the invention enables the stickout to be adjusted flexibly and varied easily, even during a welding operation. By setting the stickout, the resistance may also be adjusted steplessly. Finally, in this way it is possible to influence the Joulean heating of the wire electrode. In particular, length l of the stickout is used to adjust resistance R according to the following formula:

$$R = ρ \frac{l}{A}$$

In this formula, A is the cross sectional area of the wire electrode, and ρ is the specific electrical resistance thereof. In particular, the stickout is adjusted in a range between 1 mm and 500 mm. Different electrical resistances for different diameters and with different materials of different wire electrodes that generate different amounts of Joulean heating can be rendered uniform by means of variable stickout.

In order to adjust the stickout in the manner according to the invention, no complicated conversion work is required on a GMAW torch. Existing elements of the torch, such as a shielding gas nozzle, a shielding gas cover, can be retained.

According to a further advantageous aspect of the invention, a melting power is set as the parameter that influences the Joulean heating of the wire electrode. In conventional GMAW methods, the melting power is rigidly correlated with the amount of energy that is introduced into the workpiece. Since the invention makes it possible to heat the wire electrode from the inside by deliberately influencing the Joulean heating, and from the outside with the welding arc, the melting power may be rendered largely independent of the amount of energy that is introduced into the workpiece. With the invention, the melting power that must be introduced into the wire electrode into order to melt and separate the weld beads no longer has to be introduced solely by the welding arc. The quantity of energy introduced into the wire electrode may therefore be set differently from the quantity of energy introduced into the workpiece. The melting power may be increased by a multiple, without having to raise the quantity of energy that is introduced into the workpiece via the welding arc. In this way, the melting power may be adjusted with much greater flexibility than previously, largely without reference to the amount of energy introduced into the base material.

Particularly modern high and higher strength steels are sensitive. If such steels or other temperature-sensitive material are used as workpieces for the GMAW method, for example, the heat supply must be controlled very precisely. Since the melting power and the quantity of energy introduced into the workpiece are so firmly correlated in conventional GMAW methods, this energy input and consequently also the heat supply cannot be varied flexibly, with the result that too much energy is introduced into the workpiece. Under certain circumstances, therefore, conventional GMAW methods cannot be used for welding certain temperature-sensitive materials, or only with elaborate pre- and postheating processes of the workpiece.

Particularly when soldering and additive welding, the basic material should be melted as little as possible, preferably not at all. Since in conventional GMAW methods the melting power is rigidly correlated with the amount of energy that is introduced into the workpiece, this energy input and consequently also the heat supply cannot be varied flexibly, with the result that too much energy is introduced into the workpiece. The invention enables the melting power to be increased while the arc power remains unchanged, so that the welding speed can be increased and consequently less energy (pilot energy) is introduced into the workpiece. Exactly the same effect is achieved if the welding arc power is reduced, but the melting power can be kept constant by increasing the resistance heating or Joulean heating. In this way too, the energy input into the workpiece can be reduced while maintaining a constant welding speed.

The invention makes it possible to vary the energy input into the workpiece by the welding arc largely independently of the melting power of the additive material. The energy introduced and the supply of heat may thus be adapted flexibly to the material that is to be welded without affecting the melting of the beads. The GMAW method according to the invention may thus be used for welding all kinds of materials even those that are heat-sensitive. Elaborate processes for preheating and postheating the workpiece are not necessary for the GMAW method according to the invention. Accordingly, the pilot energy can be reduced for temperature-sensitive workpieces.

In a preferred variant of the invention, all parameters that influence the Joulean heating of the wire electrode are set. In this way, the Joulean heating of the wire electrode itself may be adjusted. The electrical power P converted at the wire electrode by the welding current (with current strength I) via the current contact point and the stickout l set therewith, may be set in accordance with the following formula:

$$P = {I}^{2} R = {I}^{2} ρ \frac{l}{A}$$

The Joulean heating ΔW over a period of time Δt is calculated from this electrical power:

$$Δ W = P Δ t = {I}^{2} ρ \frac{l}{A} Δ t$$

In a preferred variant of the invention, the parameter that influences the Joulean heating of the wire electrode is set at the start and the end of the gas metal arc welding process. The rigid correlation between melting power and energy input into the workpiece that is a feature of conventional GMAW methods causes problems at both the start and the end of the welding process. At the start, the workpiece is still cold, and too little energy is available for melting the workpiece. However the wire electrode is already melted with the preset melting power, with the result that the melted wire electrode or the melted filler material drips onto the workpiece. This often leads to the formation of cracks in the workpiece, or inadequate initial or complete melting of the workpiece. On the other hand, at the end of the welding operation, there is a great deal of energy in the workpiece, and craters (called end craters) are often formed and are difficult to fill. Therefore, it is often necessary to weld on lead-in and lead-out welding strips, which are extremely time-intensive, are only need for the start and end of the welding process, and must be removed again after the welding process is complete. If the parameters that influence Joulean heating—particularly the current contact point and the stickout—are set appropriately these lead-in and lead-out strips are no longer required, because the melting power can be adjusted to the current welding situation while keeping the welding arc power constant. Moreover, cracks in the workpiece, inadequate melting profiles and craters at the start and end of the welding process are avoided.

Furthermore, in conventional GMAW processes, it is difficult to stabilise the welding process at the start thereof. The wire electrode and the additive material are initially heated up over a relatively long period, until temperature balance is reached. This causes the electrical resistance of the wire electrode to change, since it is temperature-dependent. A total voltage is used by the welding current source to adjust the arc length. This total voltage is usually not measured until it reaches the welding machine. This variable electrical resistance of the wire electrode is incorporated in a regulating voltage at the start of the welding process. In the GMAW process according to the invention, the welding arc, or the length of the welding arc, can be adjusted precisely and flexibly at the start of the welding process by appropriate setting of the current contact point and the stickout. This enables the welding process to be stabilised very quickly after it has started. In particular, the wire electrode is briefly brought into contact with the workpiece and a low current is passed for the purpose of measuring and compensating for the electrical resistance thereof.

In a further preferred variation of the invention, the parameter that influences the Joulean heating of the wire electrode is adjusted while the gas metal arc welding process is in progress, in particular dynamically. A change in welding conditions can be influenced by changing the parameter and therewith also the Joulean heating. For example, geometrical conditions of the workpiece or component may result in a variation in heat dissipation and thus also to a change in the energy required. Effects of such kind may be heating by (dynamic) variation or adjustment of Joulean heating. In addition, the molten bead may be affected via the Joulean heating. In particular, the size of the bead may be varied in this way. Joulean heating may particularly be adjusted during the gas metal arc welding process in such manner that the size of the bead is adapted to a gap dimension. This gap dimension may be captured (online) during the gas metal arc welding process, for example by a suitable advancing sensor.

According to an advantageous variant, the at least one parameter that influences the Joulean heating of the wire electrode is adjusted in such manner that the welding arc burns in the manner of a spray arc, or more preferably a pulsed arc. In particular, the current contact point and/or the stickout is/are adjusted in this context.

In order to be able to achieve different melting powers (for different joining tasks), with the GM arc welding process, different welding torch operating states can be set, most particularly the spray arc or the pulsed arc. In conventional GMAW methods, however, these different welding arc operating states are limited to certain current ranges of the welding current, and therewith also to certain wire feed rates. By appropriate setting of the current contact point, or the stickout in the GMAW method according to the invention, it is possible to extend these certain current ranges and wire feed rates at which the different welding arc operating modes can be used. A possible useful range of particularly efficient and useful welding arc operating modes, such as spray arc or pulsed arc in particular, may thus be extended. Unfavourable, awkward welding arc operating modes such as the transitional are, are thus avoided.

At high wire advance rates, the material transition switches from a pulsed arc to the spray arc. As the current strength increases the end of the wire electrode is heated more intensely, so that the surface tension at the wire tip and the weld bead is reduced. If the current contact point is set for high welding current strengths such that the stickout gets shorter, the wire electrode is not heated as intensely and the welding arc burns as a pulsed arc even for high welding current strengths. On the other hand, if the current contact point is set for low welding current strengths such that the stickout gets longer, the wire electrode is heated more intensely and the welding arc burns as a pulsed arc even at low welding current strengths.

Similarly, the welding arc can be forced to burn as a sprayed arc at low current strengths, at which it normally burns as a transition arc. In this context, the current contact point is set such that the stickout gets longer, with the effect that the wire electrode is heated more intensely and the welding arc burns as a sprayed arc. At very fast wire advance rates, the material transition switches from a spray arc to the rotating arc, which is very difficult to control. If the current contact point is set for fast wire feed rates such that the stickout gets shorter, the wire electrode is not heated as intensely, so the welding arc burns as a sprayed arc even for very fast wire feed rates.

A heating current is preferably applied to the wire electrode as well as the welding current. This heating current particularly flows through the wire electrode or an appropriate part of the wire electrode in a separate current circuit (heating current circuit). In particular, the heating current and the heating current circuit are entirely independent of the welding current and the welding current circuit. The heating current (or the Joulean heating generated by the heating current) provides heat to the wire electrode in addition to the welding current (or the Joulean heating generated by the welding current). Such a heating current is particularly advantageous for use with relatively thick wire electrodes that have a large cross sectional area, or for wire electrodes made from materials with good (electrical) thermal conductivity, such as aluminium.

In particular in this context, the heating current is set as the parameter that influences Joulean heating of the wire electrode. At the same time, little or no additional space is required for such a heating current circuit. Moreover, no components on the torch have to be moved (not even the current contact element) if the heating current is set as the parameter, and Joulean heating of the wire electrode can still be influenced. Most noteworthy, however, is the ability also to adjust both the heating current and the current contact point as parameters that influence Joulean heating of the wire electrode.

Preferably, a gas is directed at the wire electrode in the form of a gas stream. In particular, the gas stream is directed at a part of the wire electrode that is heated by the set or modified Joulean heating, more preferably at the part of the wire electrode that is determined by the stickout. Certain chemical reactions can be initiated or prevented by directing the flow of gas in targeted manner over the wire electrode that has been heated by Joulean heating. If an oxidising gas is used, a surface tension of the beads can be lowered by pre-oxidation of the wire electrode. Additionally, residues on the wire electrode can be burned off. If an inert or reducing gas is used, certain chemical reactions can be avoided, thereby increasing the surface tension of the bead.

The invention further relates to a device for gas metal arc welding. Variations of said device according to the invention will be evident by analogy from the preceding description of the method according to the invention. The device for gas metal arc welding according to the invention its designed in such manner that at least one parameter that influences the Joulean heating of the wire electrode may be adjusted according to a variation of the method according to the invention.

In a preferred variation, the device for gas metal arc welding according to the invention has a current contact element that is configured to adjust the current contact point or the location thereof on the wire electrode precisely and, in particular, steplessly. In particular, the welding current may be transmitted consistently to a defined point on the wire electrode by means of the current contact element. In particular, the stickout is also adjusted by means of the current contact element. In this way, the melting power and Joulean heating in particular are also adjusted by means of the current contact element.

In this context, the current contact element may have the form of a conventional current contact nozzle with one or more sliding contacts. The current contact element may also be designed for example such that it has no siding contacts for transferring the welding current to the wire electrode.

In particular, the current contact element is moved and adjusted mechanically (by hand or by motor, for example). This mechanical adjustment is particularly advantageous in the context of manual gas metal arc welding processes. Alternatively or in addition thereto, the current contact element may also be adjusted electrically. This method of adjustment is particularly advantageous in the context of automated gas metal arc welding processes. For example, if an additional heating current circuit besides the welding current is used to energise the wire electrode, the current contact element may also be designed to be permanently fixed and immobile.

The device according to the invention may comprise guidance elements, such as bushings, pipes, rollers or wire guides to move the wire electrode. Such guidance elements are particularly advantageous for large stickouts, to compensate for a curvature of the wire electrode, and to support the wire electrode when it is less rigid due to the effect of the Joulean heating. Such guidance elements are particularly constructed from materials to which weld spatters do not stick, for example ceramic materials among others. In particular, the guidance elements are electrically non-conductive.

In an advantageous variation, the current contact element has at least one roller, which is in contact with the wire electrode. Particularly the welding current is applied to the wire electrode via said one or more roller. The roller serves as a localised current contact point which, unlike a sliding contact, is of fixed definition and does not change. Sliding contacts are subject to significant wear in conventional GMAW processes due to the relative movement between the wire electrode and the current contact nozzle, so that the conditions of the welding process are changing constantly. Sliding contacts must therefore be replaced frequently. It is very difficult to predict when a current contact will fail. On the other hand, a significant advantage of rollers and rolling contacts is that wear is very low, since very little relative movement takes place. Consequently they only need to be replaced extremely rarely, if at all. With rollers or rolling contacts it is very difficult if not impossible for the wire electrode to suffer burning due to sticking contact or for the wire electrode to be welded to the roller. Thus, a sudden counterforce, which might bend the wire electrode, cannot occur.

The punctiform current contact point is a single-point contact site, where the roller is in contact with and touches the wire electrode. With rollers of this kind as the current contact element, said current contact point may thus be adjusted extremely accurately. In this way, the occurrence of undesirable small arcs can be prevented, since the punctiform current contact point is permanently in contact with the wire electrode. This also renders the GMAW method considerably more precise and easier to regulate. By adjusting the resistance heating or Joulean heating, the current flow in the wire electrode can be converted into heat almost without loss, so that the gas metal arc welding method makes more efficient use of resources and the effectiveness and profitability thereof is increased. The precise adjustment of the current contact point and the precise regulation of the welding process also help to simplify the complete mechanisation or automation of the gas metal arc welding process.

The current contact element preferably comprises one or more sliding contacts, which are in contact with the roller or rollers on the side farthest from the wire electrode. The welding current is directed to the at least one roller via these sliding contacts. These sliding contacts are pressed against the rollers particularly by mechanical springs or similar readjustment mechanisms. This enables the roller or rollers to be moved against the wire electrode with a defined force.

The wire advance speed of the wire electrode is preferably determined by means of the roller or rollers. The roller or rollers are in operative connection with a measurement unit for this purpose. The speed at which the roller or rollers turn is correlated with the wire advance speed. The measurement unit therefore determines a rotating speed of the roller or rollers, and calculates the wire advance speed from this.

According to a preferred variation, the device according to the invention has a cascaded current contact element. A cascaded current contact element consists of multiple conventional current contact nozzles and/or multiple current contact elements as described in the preceding, arranged one after the other in each case, and separated from each other by an insulator. A cascaded current contact element guarantees optimum support for the heating wire electrode. The individual current contact elements or current contact nozzles can be energised via circuit breakers and/or via a movable sliding contact. In this context, the internal diameter of the insulator (particularly ceramic) is substantially the same as the internal diameter of the current contact elements or current contact nozzles. The wire electrode is thus supported optimally, even in the case of exceptional lengths between the current contact point and the welding arc contact point.

### BRIEF DESCRIPTION OF THE DRAWINGS

The invention and its advantages will now be explained further with reference to the accompanying drawing. In the drawing:

FIG. 1 is a diagrammatic representation of a variation of a device for gas metal arc welding according to the invention, which is configured to perform an embodiment of the method according to the invention.

FIG. 2 is a diagrammatic representation of a variation of a current contact element of a device for gas metal arc welding according to the invention.

FIG. 3 is a diagrammatic representation in a perspective side view of a preferred variation of a current contact element of a device for gas metal arc welding according to the invention.

FIG. 4 is a diagrammatic representation in a perspective side view of another preferred variation of a current contact element of a device for gas metal arc welding according to the invention.

FIG. 5 is a diagrammatic representation of another variation of a device for gas metal arc welding according to the invention.

FIG. 6 is a diagrammatic representation of another preferred variation of a current contact element of a device for gas metal arc welding according to the invention.

### DETAILED DESCRIPTION OF THE INVENTION

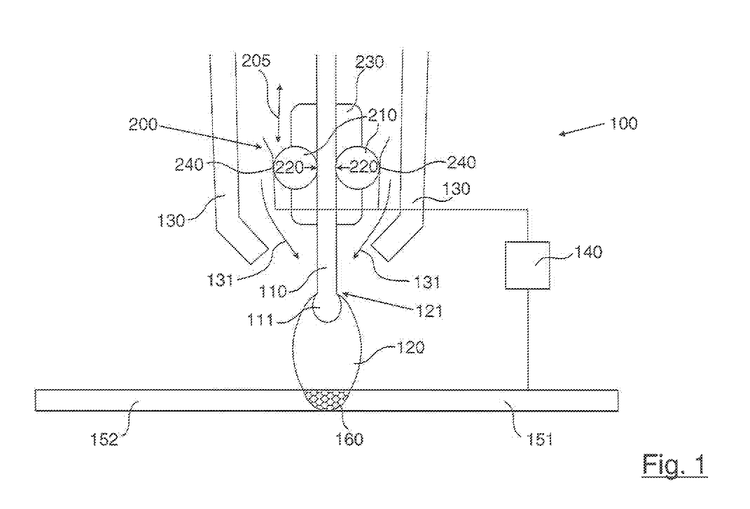

FIG. 1 is a diagrammatic illustration of a preferred variation of a device according to the invention for gas metal arc welding in the form of a GMAW torch, designated with 100.

A first workpiece 151 is welded to a second workpiece 152 by means of a joining process using GMAW torch 100. GMAW device 100 comprises a current conducting wire electrode 110 in the form of a wire. GMAW torch 100 comprises a current contact element 200.

A welding current is applied to wire electrode 110 via current contact element 200. The welding current is supplied by a welding current source 140. Welding current source 140 is connected electrically to current contact element 200 and first workpiece 151 (shown schematically). The welding current causes a welding arc 120 to burn between wire electrode 110 and first workpiece 151.

A current contact point, through which the welding current flows or is transferred to wire electrode 110, may be adjusted precisely by means of current contact element 200. Current contact element 200 comprises a guide 230. Rollers 210 are mounted on said guide 230. Said rollers 210 are in connection with wire electrode 110. Each of rollers 230 touches wire electrode 110 at a defined point 220. Said defined point 220 is current contact point 220, where the welding current is transferred to wire electrode 110. Rollers 210 may be connected to welding current source 140 via sliding contacts 240, for example, and pressed against wire electrode 110 by said sliding contacts.

Current contact element 200 is slidable along wire electrode 110, indicated by double arrow 205. This enables the position of current contact point 220 to be adjusted on wire electrode 110. The sliding movement of current contact element 200 and therewith the adjustment of current contact point 220 may be effected manually, pneumatically and/or by motorised means.

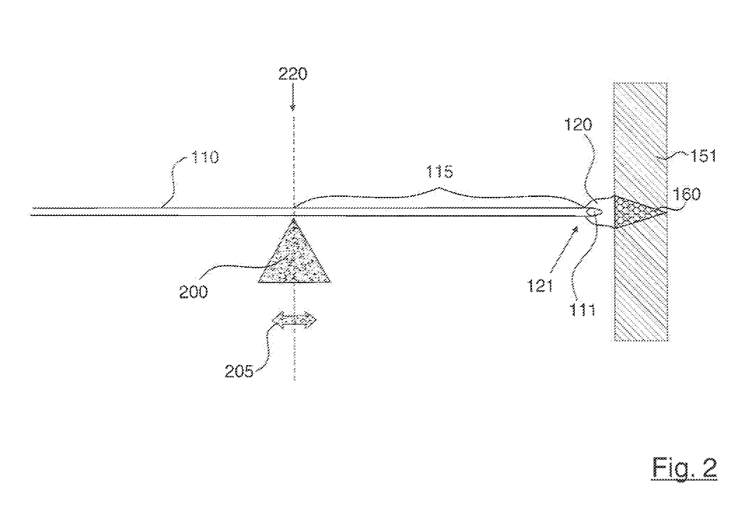

The position of current contact point 220 on wire electrode 110 may also be used to set a stickout 115 of wire electrode 110. To illustrate stickout 115 more clearly, in FIG. 2 a greatly simplified current contact element 200 is shown. In this figure, stickout 115 is the length between current contact point 220 and a welding arc contact point 121. Welding arc contact point 121 is a position on the wire electrode where welding arc 120 comes into contact with wire electrode 120. Stickout 115 can be adjusted steplessly by means of current contact element 200.

Joulean heating is set by the precise adjustment of current contact point 220, or stickout 115. Joulean heating is defined as heat energy per unit of time, by which the wire electrode 110 is heated due to its resistance energy and the welding current. The interior of wire electrode 110 is heated largely by Joulean heating. Wire electrode 110 is heated from the outside by welding arc 120, particularly in the area close to welding arc contact point 121. The introduction of energy into wire electrode 110 by Joulean heating and welding arc 120 causes wire electrode 110 to melt, and a flowable, molten bead 111 forms.

Bead 120 finally separates itself from wire electrode 110 and becomes a molten bath 160, forming the weld seam (joining connection between workpieces 151 and 152). Wire electrode 110 is advanced continuously at a certain wire advance speed throughout the process.

Wire electrode 110 can be melted more effectively and bead 111 can be formed considerably more simply than in conventional GMAW processes by the precise setting of current contact point 220, the adjustment or stickout 115 and the targeted adjustment of Joulean heating. Bead 111 is heated evenly, from the inside by Joulean heating and from the outside by welding arc 120. In this way, a maximum temperature of bead 111 is lowered. It is not necessary to overheat wire electrode 110 so that bead 111 is formed and separated. The invention enables emissions in the form of welding smoke to be reduced. Health risks associated with GMAW operations are reduced, and occupational safety is increased.

In particular, GMAW torch 100 according to FIG. 1 is also furnished with a gas nozzle 130 for the purpose of directing gas in the form of a gas stream—indicated with reference sign 131—toward the wire electrode. In particular, gas stream 131 is directed thereby toward the part of wire electrode 110 that is defined by the stickout. GMAW torch 100 may a so be furnished with additional nozzles, for example a shielding gas nozzle for supplying a shielding gas.

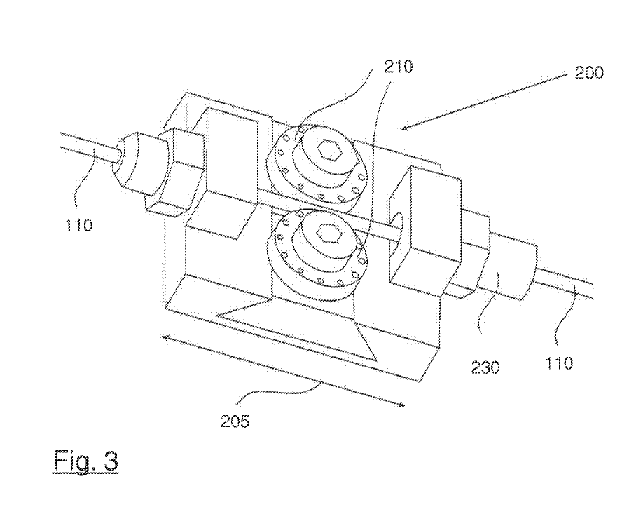

FIG. 3 shows a diagrammatic illustration of a preferred variation of a current contact element 200 according to FIG. 1 in a perspective side view. As in FIG. 1, the current contact element 200 of FIG. 3 has two rollers 210, which are mounted on a guide 230. Wire electrode 110 may be inserted into guide 230. The rollers touch the wire electrode at a defined current contact point. Guide 230 and therewith also current contact element 200 may be moved along wire electrode 110 in the direction of double arrow 205.

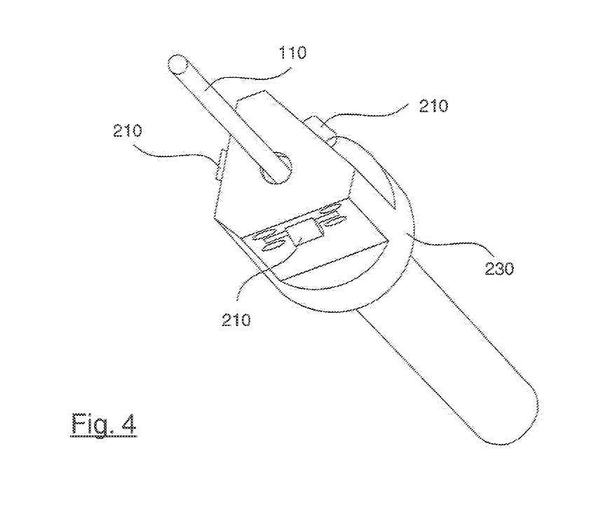

A perspective side view of another preferred variation of a current contact element 200 is illustrated diagrammatically in FIG. 4. Current contact element 200 according to FIG. 4 has three rollers 200, which are mounted on a guide 230.

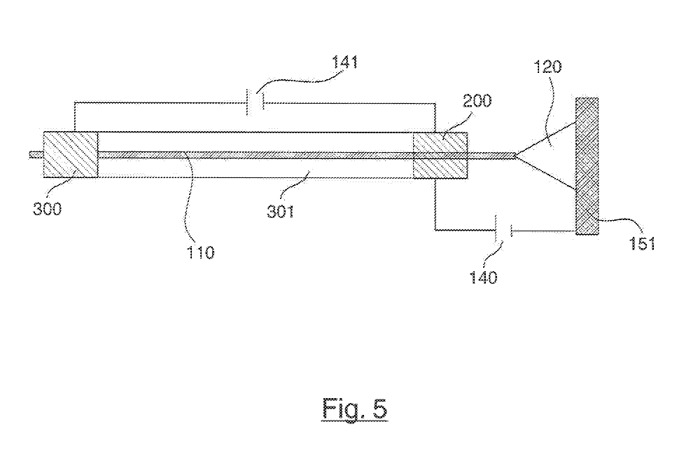

FIG. 5 is a diagrammatic illustration of another preferred variation of a gas metal arc welding torch according to the invention. The GMAW torch has a current contact element 200 that is electrically connected to one terminal of welding current source 140. The other terminal of current source 140 is connected to first workpiece 151. In addition to this welding current circuit, this variant of the gas metal arc welding torch according to the invention has a second current circuit, a “heating current circuit”. For this purpose, the GMAW torch also has a second current contact element 300. This second current contact element 300 may be configured similarly to first current contact element 200, or differently. First current contact element 200 and second current contact element 300 are connected to each other electrically via a heating current source 141. Consequently, a heating current flows across the part of wire electrode 110 between first and second current contact elements 200 and 300. The heating current thus supplies further heat to the wire electrode, in addition to the welding current. In this example, the wire electrode is encased in an insulator 301, which ensures current contact elements 200 and 300 are electrically isolated from one another.

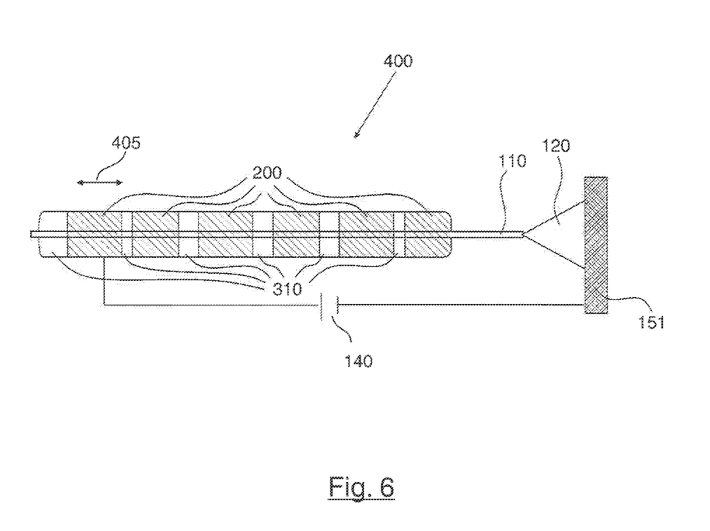

FIG. 6 is a diagrammatic illustration of another preferred variation of a current contact element. This current contact element is designed as a cascaded current contact element 400. Cascaded current contact element 400 comprises a plurality of current contact elements 200 arranged one after the other, which in particular are constructed according to the preceding description. The individual current contact elements 200 are all separated from each other by insulators 310.

One of the current contact elements 200 is electrically connected to welding current source 141, particularly via a sliding contact. This sliding contact may be moved flexibly along cascaded current contact element 400, as indicated by double arrow 405. In this way, the current contact element 200 with which welding current source 141 is electrically connected may be varied at will.

In this context, the sliding contact typically enters into connects with one current contact element 200 of cascaded current contact element 400. The sliding contact may also enter into contact simultaneously with up to three current contact elements 200 of the cascaded current contact element 400, and connect this maximum number of three current contact elements 200 simultaneously to welding current source 141.

It is also possible not to use a sliding contact, and to connect all current contact elements 200 of cascaded current contact element 400 electrically with welding current source 141. Then, particularly certain current contact elements 200 can be connected (particularly by means of circuit breakers), and the other current contact elements 200 may be isolated from the welding current source 140 (also by means of the circuit breakers).

### LIST OF REFERENCE SIGNS

100 Gas metal arc welding torch
110 Wire electrode
111 Bead
115 Stickout
120 Welding arc
121 Welding arc contact point
130 Gas nozzle
131 Gas stream
140 Welding current source
141 Heating current source
151 First workpiece
152 Second workpiece
160 Molten bath
200 Current contact element
205 Double arrow
210 Rollers
220 Current contact point
230 Guide
240 Sliding contact
300 Second current contact element
301 Insulator
310 Insulator
400 Cascaded current contact element
405 Double arrow

Having thus described the invention, what we claim is:

1. A method for gas metal arc welding, wherein a welding current is passed through a wire electrode and the wire electrode is melted by a welding arc, characterised in that at least one parameter that influences the Joulean heating of the wire electrode is adjusted.

2. The method according to claim 1, wherein a current contact point on the wire electrode on which the welding current is directed toward the wire electrode, is set as the at least one parameter that influences the Joulean heating of the wire electrode.

3. The method according to claim 2, wherein a stickout between the current contact point and a contact point of the welding arc with the wire electrode is set by means of the current contact point as the at least one parameter that influences the Joulean heating of the wire electrode.

4. The method according to claim 3, wherein the stickout is in a range between 1 mm and 500 mm.

5. The method according to claim 2, wherein a melting power is set by means of the current contact point.

6. The method according to claim 1, wherein all parameters that influence the Joulean heating of the wire electrode are set.

7. The method according to claim 1, wherein the at least one parameter that influences the Joulean heating of the wire electrode is set at the start and the end of the gas metal arc welding process.

8. The method according to claim 1, wherein the at least one parameter that influences the Joulean heating of the wire electrode is set during the gas metal arc welding process.

9. The method according to claim 8, wherein the at least one parameter that influences the Joulean heating of the wire electrode is set dynamically.

10. The method according to claim 1, wherein the at least one parameter that influences the Joulean heating of the wire electrode is set in such manner that the welding arc burns as a sprayed arc.

11. The method according to claim 1, wherein the at least one parameter that influences the Joulean heating of the wire electrode is set in such manner that the welding arc burns as a pulsed arc.

12. The method according to claim 1, wherein a heating current is passed through the wire electrode in addition to the welding current.

13. The method according to claim 1, wherein a gas in the form of a gas stream is directed at the wire electrode.

14. A device for gas metal arc welding, comprising a wire electrode through which a welding current is passed, characterised in that the device is configured so as to adjust at least one parameter that influences Joulean heating of the wire electrode.

15. The device according to claim 14, comprising a current contact element that is configured so as to adjust a current contact point on the wire electrode at which the welding current is transferred to the wire electrode as the at least one parameter that influences Joulean heating of the wire electrode.

16. The device according to claim 14, wherein the current contact element comprises at least one roller, which is in contact with the wire electrode and via which the welding current is transferred to the wire electrode.

17. The device according to claim 16, wherein the current contact element comprises a sliding contact, which is in contact with the at least one roller and via which the welding current is transferred to the at least one roller.

18. The device according to claim 16, wherein the at least one roller is in operative connection with a measuring unit, which serves to determine a feed speed of the wire electrode.

19. The device according to claim 14, comprising a cascaded current contact element, wherein current contact elements and or current contact nozzles are arranged one after the other and are all separated from each other by insulators.
